(19) United States
(12) Patent Application Publication
(10) Pub. No.: US 2018/0225707 A1
(43) Pub. Date: Aug. 9, 2018

(54) COMPETITOR ADVERTISEMENT FAILOVER

(71) Applicant: International Business Machines Corporation, Armonk, NY (US)

(72) Inventor: Michael J. Hudson, Delray Beach, FL (US)

(21) Appl. No.: 15/425,081

(22) Filed: Feb. 6, 2017

(51) Int. Cl. G06Q 30/02

(52) U.S. Cl. CPC G06Q 30/0244; G06Q 30/0276; G06Q 30/0277

(57) ABSTRACT

Embodiments of the present invention provide a method, system and computer program product for competitor advertisement failover. The method includes selecting a message delivery format and receiving a marketing message, combining the message with the delivery format and broadcasting the combination to a set of specified recipients. Thereafter, a response to the broadcast is monitored to identify an effectiveness of the combination of the message and delivery format. Finally, on condition of determining an ineffectiveness of the combination of the message and the delivery format, a marketing message of a competitor that is compatible with the selected message delivery format is selected and combined with the selected message delivery format and broadcast to the set of specified recipients over the computer communications network.

### BACKGROUND OF THE INVENTION

### Field of the Invention

The present invention relates to e-commerce and more particularly to electronic advertisement creation and deployment in a global computer communications network.

### Description of the Related Art

E-commerce is the buying and selling of goods and services, or the transmitting of funds or data, over an electronic network, primarily the Internet. These business transactions occur either business-to-business, business-to-consumer, consumer-to-consumer or consumer-to-business. E-commerce is conducted using a variety of applications, such as electronic mail, online catalogs and shopping carts, electronic data interchange and Web services. E-commerce includes business-to-business activities and outreach such as using electronic mail for advertisements to consumers and other business prospects, as well as to transmit e-newsletters to subscribers. More recently, advertisers now entice consumers directly online, using tools such as digital coupons, social media marketing and targeted advertisements.

Of note, not everyone responds to the same advertisement in the same way. As such, in a given advertising strategy, a selected campaign may be pleasing to one set of target consumers and at the same time annoying to others. Indeed, there are several inherent negative consequences to the deployment of a digital advertisement—the cost of receipt of the advertisement by the consumer in terms of the use of mobile computing devices resources such as battery life and processing cycles to receive and display the advertisement, and the cost of data for a mobile computing device enjoying only a limited amount of data under a cellular data plan. Thus, a digital advertisement received in a mobile device that is not satisfying to the recipient has the additional effect of costing the unsatisfied consumer resources and even money.

Integral to the measurement, then, of the impact of a digital advertising campaign is the near real-time capturing of the consumer's response to a digital advertising campaign. The technology to capture data about consumer behavior in response to an advertising campaign, and to calculate return on investment with respect to an advertising campaign has advanced rapidly in recent years. Now, one is able to track a potential consumer as the customer interacts with multiple media sources including the Web, the mobile Web, Internet radio and online video so as to personalize the advertising experience of the consumer based not only upon the interests of the consumer, but also upon the reaction of the consumer to ongoing and historical advertising campaigns. Such technologies include tracking, analytics and personalization.

### BRIEF SUMMARY OF THE INVENTION

Embodiments of the present invention address deficiencies of the art in respect to e-commerce marketing and provide a novel and non-obvious method, system and computer program product for competitor advertisement failover. In an embodiment of the invention, a competitor advertisement failover method includes selecting a message delivery format and receiving a marketing message. The message is combined with the delivery format and broadcast to a set of specified recipients over a computer communications network. Thereafter, a response to the broadcast is monitored to identify an effectiveness of the combination of the message and delivery format. Finally, on condition of determining an ineffectiveness of the combination of the message and the delivery format, a marketing message of a competitor that is compatible with the selected message delivery format is selected and combine with the selected message delivery format. The combination of the marketing message of the competitor with the selected message delivery format is then broadcast to the set of specified recipients over the computer communications network.

In one aspect of the embodiment, the selected message delivery format is a banner advertisement. In another aspect of the embodiment, the selected message delivery format is a push notification. In yet another aspect of the embodiment, the selected message delivery format is an e-mail message. In even yet another aspect of the embodiment, the selected message delivery format is streaming media. Finally, in even yet another aspect of the embodiment, the response to the broadcast is monitored by retrieving from a campaign tracking computer program metrics pertaining to the broadcast.

In another embodiment of the invention, a data processing system is configured for competitor advertisement failover. The system includes a host computing platform with one or more computers each with memory and at least one processor. The system also includes an e-commerce marketing computer program executing in the memory of the host computing platform and both providing a user interface through which a marketing message is received along with a selected message delivery format and also combining the message with the delivery format and broadcasting the combination to a set of specified recipients over a computer communications network. Finally, the system includes a competitor advertisement failover module coupled to the e-commerce marketing computer program.

The module includes program code enabled during execution in the host computing platform to monitor a response to the broadcast to identify an effectiveness of the combination of the message and delivery format and, on condition of determining an ineffectiveness of the combination of the message and the delivery format, to select a marketing message of a competitor that is compatible with the selected message delivery format and combine the marketing message of the competitor with the selected message delivery format and direct the e-commerce marketing computer program to broadcast the combination of the marketing message of the competitor with the selected message delivery format to the set of specified recipients over the computer communications network.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for competitor advertisement failover;

FIG. 2 is a schematic illustration of a data processing system configured for competitor advertisement failover; and,

FIG. 3 is a flow chart illustrating a process for competitor advertisement failover.

### DETAILED DESCRIPTION OF THE INVENTION

Embodiments of the invention provide for competitor advertisement failover. In accordance with an embodiment of the invention, an e-commerce advertisement delivery format is selected and an e-commerce message generated. The generated e-commerce message is included in the delivery format and broadcast over a global computer communications network to different end users. Thereafter, the response by the different end users is monitored. If the response is determined to indicate an ineffectiveness of the e-commerce message, a different e-commerce message of a competitor is identified as being compatible with the selected delivery format and included in the delivery format. Finally, the selected delivery format with the different e-commerce message of the competitor is broadcast over the global computer communications network to the different end users.

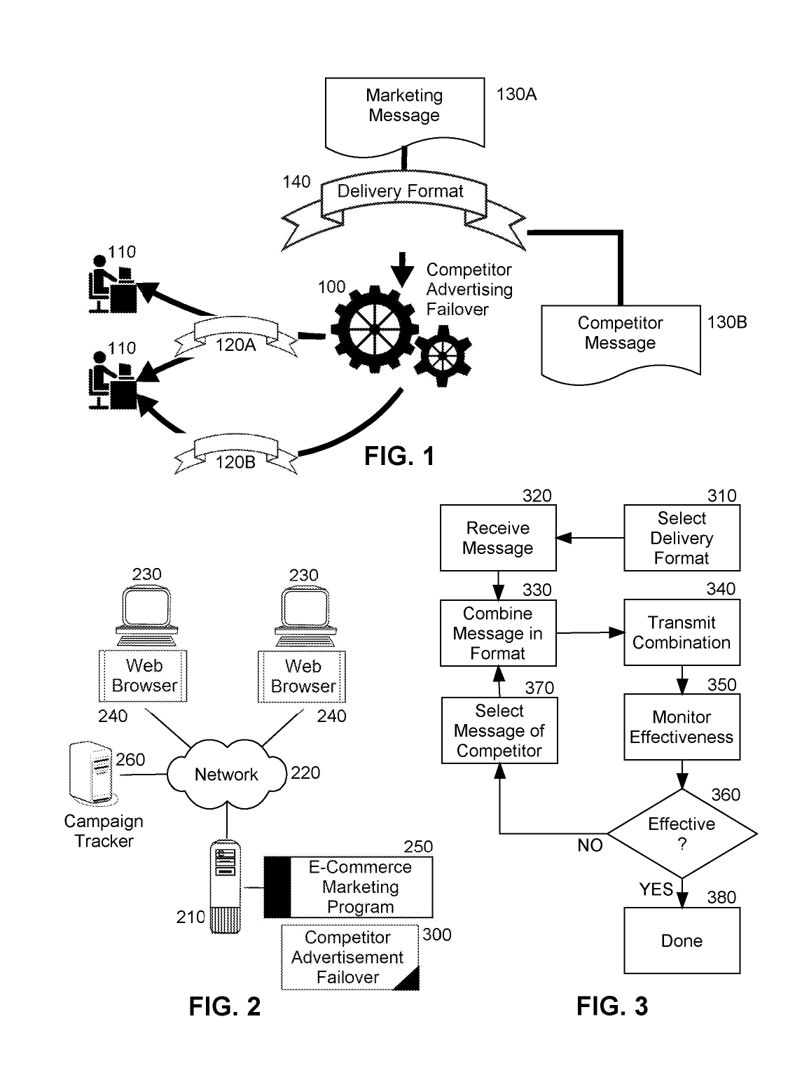

In further illustration, FIG. 1 is a pictorial illustration of a process for competitor advertisement failover. As shown in FIG. 1, competitor advertising failover logic 100 combines a marketing message 130A, textual in nature, with a specified delivery format, in order to produce an e-commerce advertisement 120A. The specified delivery format includes, by way of example, an e-mail message, push notification, advertising banner, text message and streaming media such as streaming audio or streaming video. In the case of an e-mail message, the marketing message 130 is inserted into an e-mail message that is then transmitted to a designated recipient by way of a mail server. In the case of a push notification, an inactive application in a client computing device is directed to display a pop-up dialog box with the marketing message 130. In the case of an advertising banner an advertisement server is directed to insert into a Web page a graphic containing the marketing message 130. In the case of a text message, the marketing message 130 is inserted into a text message. Finally, in the case of streaming media, the marketing message 130 is included as part of streaming audio or streaming video.

In any event, the competitor advertising failover logic 100 then broadcasts the e-commerce advertisement 120A to different target consumers 110. The competitor advertising failover logic 100 monitors a response to the broadcast e-commerce advertisement 120A in order to gauge an effectiveness of the broadcast e-commerce advertisement 120A. For instance, a campaign tracking application (not shown) may monitor the behavior of each of the different target consumers 110 in order to gauge an effectiveness or ineffectiveness of the broadcast e-commerce advertisement 120A. The monitoring may include tracking mouse clicks or other user inputs in connection with the broadcast e-commerce advertisement 120A, or monitoring a period of time during which each of the target consumers 110 remains viewing a message or Web page containing the broadcast e-commerce advertisement 120A beyond a threshold value indicating an effectiveness of the broadcast e-commerce advertisement 120A, or monitoring a period of time elapsed in which an expected mouse click in connection with the broadcast e-commerce advertisement 120A is to occur but does not occur indicating an ineffectiveness of the broadcast e-commerce advertisement 120A.

On condition that the competitor advertising failover logic 100 determines that the broadcast e-commerce advertisement 120A has been ineffective, the competitor advertising failover logic 100 locates and selects a competitor message 130B that includes an advertising message of a competitor deemed compatible with the selected delivery format 140. Thereafter, the competitor advertising failover logic 100 combines the competitor message 130B with the delivery format 140 to produce a competitor originated advertisement 120B and the competitor advertising failover logic 100 broadcasts the competitor originated advertisement 120B to the target consumers 110.

The process described in connection with FIG. 1 may be implemented in a data processing system. In yet further illustration, FIG. 2 schematically shows a data processing system configured for competitor advertisement failover. The system includes a host computing platform 210 that includes one or more computers, each with memory and at least one processor, communicatively coupled over computer communications network 220 to different client computers 230, each supporting the operation of a Web browser 240.

An e-commerce marketing program 250 operates within the host computing platform 210. The e-commerce marketing program 250 provides an interface through which end user generated advertisements are created by combining textual marketing messages with selected delivery formats and broadcasting the combinations over computer communications network 220 to different sets of target consumers at the client computers 230. As well, a competitor advertisement failover module 300 is coupled to the e-commerce marketing program 250. The competitor advertisement failover module 300 includes program code that when executed in the memory of the host computing platform 210 is enabled to receive from a campaign tracker 260 monitored data pertaining to a response by the target consumers evident through respective ones of the Web browsers 240 to an advertisement broadcast by the e-commerce marketing program 250.

Subsequently, to the extent that the monitored data is indicative of the advertisement having been ineffective, the program code is additionally enabled to locate a marketing message by a competitor that is compatible with a selected delivery format of the ineffective advertisement, to form a new advertisement by combining the marketing message of the competitor with the delivery format of the ineffective advertisement, and to direct the e-commerce marketing program 250 to broadcast the new advertisement to the target consumers over the computer communications network 220.

In even yet further illustration of the operation of the competitor advertisement failover module 300, FIG. 3 is a flow chart illustrating a process for competitor advertisement failover. The process begins in block 310 with the selection of a delivery format for a marketing message. In block 320, a marketing message is specified in an input field of a user interface to an e-commerce marketing program. In block 330, the marketing message is combined with the selected delivery format that is instrumented as actionable in the sense that a user interaction occurring in connection with the selected delivery format is recorded for subsequent analysis, such as in connection with a campaign tracker. In block 340, the combination is transmitted to different target consumers over a computer communications network for display in a corresponding user interface of a corresponding computing device such as a Web browser in a personal computer, or in an operating system of a mobile computing device.

In block 350, the effectiveness of the transmitted combination is monitored, for instance by receiving Web response data from a campaign tracker. In this regard, in response to a user interaction with the transmitted combination including a mouse click or a set focus event, a message is sent by the transmitted combination to the campaign tracker which records the interaction in connection with the transmitted combination, including an identification of the individual engaging in the interaction and the identification of the transmitted combination as well as a time or date stamp and a Web page or network address from which the interaction occurs. The responses to different user interactions with different marketing messages including the transmitted combination may be stored in a table by the campaign tracker and queried by a communicatively coupled logic. In some scenarios and embodiments, some types of interactions may indicate types of sentiments. For example, a first type of interaction is known to correlate to a first type of user sentiment. As such, a determination that a required number of user interactions of the first type have occurred indicates the first type of sentiment is present in the group of users that received the transmitted combination.

In decision block 360, it is then determined if the transmitted combination has been effective. That is to say, the table of the campaign tracker may be queried to determine if a requisite number of interactions with the transmitted combination has occurred within a threshold period of time. In the event that it is determined that the transmitted combination has not been effective—such that a requisite number of interactions with the transmitted combination has not occurred within a threshold period of time, in block 370 a marketing message of a competitor is located and selected. For instance, a Web site of a competitor is parsed to identify one or more different marketing messages. As well, it is determined from those Web sites a corresponding delivery format for each of the different marketing messages such as by way of meta-data annotating the marketing messages and indicating a particular delivery format.

In block 330, the selected marketing message of the competitor is combined with the delivery format of the transmitted combination and the new combination is then transmitted to the target consumers. In some embodiments and scenarios, a number of target consumers that receives the new combination is not the same as the number of consumers that received the previously transmitted combination. In some embodiments, the number of consumers that receives the new combination is configured based on a prediction that such a number of consumers will result in a requisite number of interactions with the new combination. In one example, a first combination includes a first product. The first combination is transmitted to a first group of users and results in a number of user interactions that indicate that a first type of sentiment is present in that group of users. A second product is determined to have a second type of sentiment associated with it, above a threshold. A second group of users is determined, such that the number of users in the second group is predicted to result in an expression of the first sentiment for the second product above a threshold. The new combination, which includes the second product, is then sent to the second group of users. In block 350, again the effectiveness of the newly transmitted combination is monitored and, the process repeats if in decision block 360 it is determined that the newly transmitted combination is not effective. But, if in decision block 360 it is determined that the newly transmitted combination is effective, the process ends in block 380.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A competitor advertisement failover method comprising:
selecting a message delivery format by an e-commerce marketing computer program executing in memory of a computer;
receiving a marketing message in an input field of a user interface to the e-commerce marketing computer program;
combining the message with the delivery format in the e-commerce marketing computer program and broadcasting by the e-commerce marketing computer program the combination to a set of specified recipients over a computer communications network;
monitoring in the e-commerce marketing computer program a response to the broadcast to identify an effectiveness of the combination of the message and delivery format; and,
on condition of determining an ineffectiveness of the combination of the message and the delivery format:
selecting a marketing message of a competitor that is compatible with the selected message delivery format,
combining the marketing message of the competitor with the selected message delivery format, and
broadcasting the combination of the marketing message of the competitor with the selected message delivery format to the set of specified recipients over the computer communications network.

2. The method of claim 1, wherein the selected message delivery format is a banner advertisement.

3. The method of claim 1, wherein the selected message delivery format is a push notification.

4. The method of claim 1, wherein the selected message delivery format is an e-mail message.

5. The method of claim 1, wherein the selected message delivery format is a streaming media message.

6. The method of claim 1, wherein the response to the broadcast is monitored by retrieving from a campaign tracking computer program metrics pertaining to the broadcast.

7. The method of claim 1, wherein the combination of the marketing message of the competitor with the selected message delivery format is broadcast to only a subset of the set of specified recipients over the computer communications network.

8. A data processing system configured for competitor advertisement failover, the system comprising:
a host computing platform comprising one or more computers each with memory and at least one processor;
an e-commerce marketing computer program executing in the memory of the host computing platform and both providing a user interface through which a marketing message is received along with a selected message delivery format and also combining the message with the delivery format and broadcasting the combination to a set of specified recipients over a computer communications network; and,
a competitor advertisement failover module coupled to the e-commerce marketing computer program, the module comprising program code enabled during execution in the host computing platform to monitor a response to the broadcast to identify an effectiveness of the combination of the message and delivery format and, on condition of determining an ineffectiveness of the combination of the message and the delivery format:
to select a marketing message of a competitor that is compatible with the selected message delivery format,
combine the marketing message of the competitor with the selected message delivery format, and
direct the e-commerce marketing computer program to broadcast the combination of the marketing message of the competitor with the selected message delivery format to the set of specified recipients over the computer communications network.

9. The system of claim 8, wherein the selected message delivery format is a banner advertisement.

10. The system of claim 8, wherein the selected message delivery format is a push notification.

11. The system of claim 8, wherein the selected message delivery format is an e-mail message.

12. The system of claim 8, wherein the selected message delivery format is a streaming media message.

13. The system of claim 8, wherein the response to the broadcast is monitored by retrieving from a campaign tracking computer program metrics pertaining to the broadcast.

14. A computer program product for competitor advertisement failover, the computer program product comprising a computer readable storage medium having program instructions embodied therewith, the program instructions executable by a device to cause the device to perform a method comprising:
selecting a message delivery format by an e-commerce marketing computer program executing in memory of a computer;
receiving a marketing message in an input field of a user interface to the e-commerce marketing computer program;
combining the message with the delivery format in the e-commerce marketing computer program and broadcasting by the e-commerce marketing computer program the combination to a set of specified recipients over a computer communications network;
monitoring in the e-commerce marketing computer program a response to the broadcast to identify an effectiveness of the combination of the message and delivery format; and,
on condition of determining an ineffectiveness of the combination of the message and the delivery format:
selecting a marketing message of a competitor that is compatible with the selected message delivery format,
combining the marketing message of the competitor with the selected message delivery format, and
broadcasting the combination of the marketing message of the competitor with the selected message delivery format to the set of specified recipients over the computer communications network.

15. The computer program product of claim 14, wherein the selected message delivery format is a banner advertisement.

16. The computer program product of claim 14, wherein the selected message delivery format is a push notification.

17. The computer program product of claim 14, wherein the selected message delivery format is an e-mail message.

18. The computer program product of claim 14, wherein the selected message delivery format is a streaming media message.

19. The computer program product of claim 14, wherein the response to the broadcast is monitored by retrieving from a campaign tracking computer program metrics pertaining to the broadcast.

20. The computer program product of claim 14, wherein the combination of the marketing message of the competitor with the selected message delivery format is broadcast to only a subset of the set of specified recipients over the computer communications network.
